(19) United States
(12) Patent Application Publication
(10) Pub. No.: US 2023/0330959 A1
(43) Pub. Date: Oct. 19, 2023

(54) A method of heat sealing a container closure section liquid proof

(71) Applicant: Wilhelm KULLBERG, Sacramento, CA (US)

(72) Inventor: Wilhelm KULLBERG, Sacramento, CA (US)

(21) Appl. No.: 18/445,088

(22) Filed: Mar. 30, 2023

(30) Foreign Application Priority Data
Oct. 1, 2020 (IR) 2020/0222

(51) Int. Cl. B31B 50/64; B65B 51/10; B65B 61/02; B65B 61/12

(52) U.S. Cl. CPC B31B 50/64; B65B 51/10; B65B 61/02; B65B 61/12

(57) ABSTRACT

A method of compressing & heat sealing a container closure “junction” of a 180° folded polymer coated, medium to heavy gauge, paperboard panel edge, between a polymer coated paperboard panel and a polymer coated film element edge, liquid proof.

### BACKGROUND OF THE INVENTION

The present invention is a method of compressing & heat sealing an inside liquid container closure “junction”, comprising a 180° folded polymer coated paperboard panel edge between a polymer coated paperboard panel and a polymer coated film element edge area, liquid proof.

In mass production, a compression tool generally remain in exact same precise positon during a long production cycle with large machine stroke numbers. In order to push a polymer coated paperboard sleeve onto an inside anvil without one or more polymer coated paperboard walls collapsing, a 1 mm tolerance is required. The polymer coated paperboard sleeve must therefore have a 2 mm larger cross section than the inside anvil. Because of the required inside tolerance between the rectangular polymer coated paperboard sleeve and the rectangular anvil, all container closure edges of a 180° folded polymer coated paperboard panel will wander during mass production and not end up in the same position during compression & heat sealing, either braking the 180° folded polymer coated paperboard panels edge, or forming a channel, resulting in liquid penetrating to outside the container, causing containers to leak during storage & distribution, damaging surrounding products.

The present invention applies to various polymer coated paperboard container closure designs for liquids having medium or heavy paperboard area weight with the container closures inside section of a 180° folded polymer coated paperboard panel edge compressed & heat sealed liquid proof between a polymer coated paperboard panel and a polymer film element edge.

When heat sealing using ultrasonic, an inside heated alloy anvil having a 0.0045MT-110 50 texture etched surface pattern and an ultrasonic welding sonotrode with a knurled pentahedrons/square pyramid micro pattern in the different heat sealing zones is required in order to control the energy direction for the containers closure to be heat sealed in the specific welding zones precisely, for later to be able to open the container closure flawlessly. Also, one of the 0.013-0.030″ raised half hexagon texture etched surface sections from the anvil surface, could have one side serrated edge. The multiple pentahedrons points need to be machined off to plane foreheads, commonly used to prevent multiple sharp points cutting through polymer layers. The angle between the pentahedrons panels could be 60°. Integrating a spring loaded compression tool in an ultrasonic sonotrode, introduces several other following technical problems; An activated ultrasonic sonotrode vibrate under a high frequency which will cause any moving element integrated in the ultrasonic sonotrode to interfere with the frequency and destabilize the ultrasonic welding process.

A compression & heat sealing punch's hard ball formed forehead, overlapping a junction of a pre-sealed container from the external polymer coated paperboard panel wall side with compression & heat sealing punch hardball formed forehead embedded in a flexible elastomer body, flexing sideways sealing the 180° prefolded polymer coated paperboard edge, by a non-elastic punch in drive direction, between outside said polymer coated paperboards inside panel and the polymer coated film element edge area against the heated anvil without breaking the 180° folded polymer coated paperboard edge liquid proof, according to the present invention. Vibrating the compression punch's ball formed forehead might be needed.

Coating the anvil with a non-stick polytetrafluorethylene (PTFE) coating is required, preventing polyethylene (PE) sticking to the heated alloy mandrel during the heat sealing compression process. When compressing & heat sealing multiple superimposed coated polymer coated paperboard panels with ultrasonic, all layers seals together. Preventing some areas sealing together in order to be able to open the container closure later, a non-heat sealable water based overprint varnish will be applied during the flexographic printing process in these surface areas.

After heat sealing, some film element areas are required to peel off from the polyethylene coated paperboard panel, when opening the container closure. A peel able composite layer will therefore have to be coated onto the film elements surface. A lacquer or a polymer composite coating that is peelable and at the same time provide a heat seal with sufficient strength might be a complicated application. In order to bypass this problem, according to the present invention, one side of a nonpeelable low density polyethylene (LDPE) coating of the polyester (PE) film is permanently heat sealed to a low density polyethylene (LDPE) non-peelable paperboard coating, with the other polyester (PE) film side coated with a low density polyethylene (LDPE) peelable composite layer, in which a part of the film is folded over, forming a lip along a perforated line, with the lips both peelable low density polyethylene (LDPE) peelable composite layers heat sealed together, delaminating with the lip being ripped-off alone the perforated line and remain attached to the paperboards low density polyethylene. (LDPE) non peel able layer after opening the carton closure. By installing a half way depth cutting die in the rotary creasing & cutting production tool in line with the printing press producing container blanks, the in depth polymer coated paperboard sections can be delaminated & removed by vacuum, before folded 180° in the filling machines. A recessed section of the 180° folded polymer coated paperboard edge minimizes the radius of the folded polymer coated paperboard edge heat sealed to the polymer coated film element, eliminating any liquid path.

### SUMMARY OF THE INVENTION

Accordingly, it is an object of the present invention to obviate the above-noted shortcomings & disadvantages related to known sealing methods in prior art.

It is another objective of the present invention to provide a container which will be more economical.

It is another objective of the present invention, eliminating the plastic screw caps demanded by the consumers for all state of the art liquid cartons and furthermore introducing paperboard biopolymer coatings, providing a 100% biodegradable container, preserving the environment in a more efficient way.

It is another objective of the present invention to provide a container which will reduce consumption of natural resources.

### BRIEF DESCRIPTION OF THE DRAWINGS

FIG. 1, is a magnified sectional view of a compression & heat sealing station with a 180° folded polyethylene coated paperboard panel superimposed to inside of outside polyethylene (PE) coated paperboard and an inside film element 2, with compression & heat sealing punch, having a flexible ball formed hard forehead, about to make a lean and guided imprint in the pre-folded & compressed closure, bypass the 180° folded polyethylene (PE) coated paperboard panel edge.

FIG. 2, is a magnified sectional side view of a 180° folded polyethylene coated paperboard panel edge, sealed liquid proof between the inside of outside polyethylene coated paperboard panel and inside polyethylene coated film element after compression & heat sealing, according to FIG. 1.

FIG. 3, is a plan view of an inside section of a container closure, illustrating an inside leak proof junction with the polyethylene coated film element edge overlapped by the 180° polyethylene coated paperboard panels inside edge and the inside of outside polyethylene coated paperboard panel.

FIG. 4, is a magnified isometric view with a recessed section of a 180° folded polyethylene coated paperboard panel edge.

FIG. 5, is a magnified sectional side view of a polyethylene (PE) coated paperboard panel heat sealed to a film lip.

FIG. 6, is a magnified sectional side view of a polyethylene (PE) coated paperboard panel heat sealed non peel able to a part of the film lip, with the film lip's other side peelable from the film element, delaminating and braking off along a perforated line of the film element when opening the closure.

FIG. 7, is a plan view of the ultrasonic sonotrodes knurled heat sealing pattern with diagonal & vertical oriented sealing sections having interrupted mid sections, illustrating the sealed cross section pattern of the folded flat paperboard container closure.

FIG. 8, is a top view of a polymer coated paperboard first panel with the closures opening tabs connected by two different perforation line patterns with the two perforated tabs heat sealed to a second polymer coated paperboard panel.

FIG. 9, is an isometric view of a mandrel assembly with texture etched mandrel surface having two raised half hexagon surface section surface sections and mandrel's forehead connected by four hollow pins to the mandrel base, preventing heat transfer from the heated top plate into the mandrel base.

FIG. 10, is a side view of the four mandrels indexing rotor with first mandrel to the left having a rectangular container sleeve pushed onto the mandrel by an indexing timing belt. The closure is folded between first and second mandrel station. Ultra Sonic welding stack in second mandrel station above is heat sealing the closure. Third mandrel station to the right is compressing & sealing the closure liquid proof, according to the present invention. In fourth mandrel station below, the rectangular paperboard structure including the finished folded & sealed closure is removed from the mandrel. An induction coil is heating the mandrel top plates as the top plates passing under the induction coil between fourth and first mandrel stations.

### DESCRIPTION OF THE PREFERRED EMBODIMENT

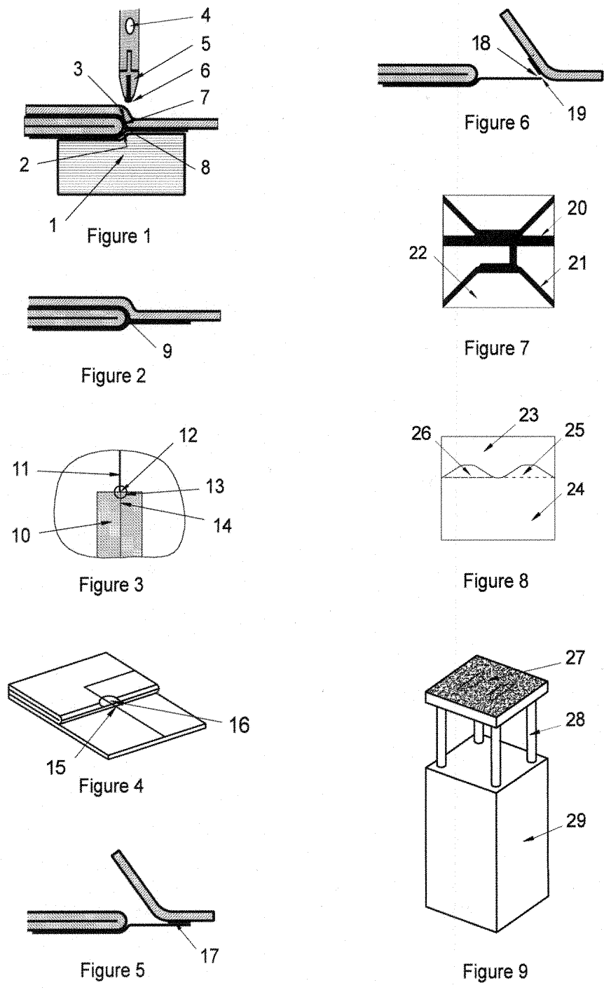

According to FIG. 1, channel 8 along 180° folded polymer coated paperboard panel edge 7, formed in a prior heat sealing station. The container closure's junction is about to be compressed & heat sealed liquid proof by compression & heat sealing punch's hard ball formed forehead 6 against heated mandrel 1, hard ball formed compression & heat-sealing punches hard forehead 6 is movable sideways in flexible elastomer body 5 during compression, sealing said 180° folded polymer coated paperboard edge 7 between outside polymer coated paperboard's inside panel 3 and said polymer coated film element edge area 2, compressing & heat sealing channel 8 liquid proof without braking the polyethylene coating of the 180° folded polyethylene coated paperboard panel edge 7. Reference #4 illustrates air or liquid passage in the hard punch forehead 6, cooling down compression & heat sealing punch's attached/adjacent flexible elastomer element 5 during long production cycles.

According to FIG. 2, illustrating liquid proof junction 9 after compressed & heat sealed liquid proof, according to the present invention.

According to FIG. 3, illustrating a top view of a section according to drawing in FIG. 2, with a polymer coated film element 10 overlapping and heat sealed to 180° folded polymer coated paperboard panel including free edge 11 with leak proof junction 12, heat sealed liquid proof by ball formed forehead, within circle 13. Reference #14 illustrates a potential liquid path, sealed liquid proof by ball formed forehead within circle 13, after compressed & heat-sealed.

According to FIG. 4, illustrating recessed edge section 16 of the 180° folded polyethylene coated paperboard panel edge with the potential of reducing and eliminating liquid path entrance 15.

According to FIG. 5, illustrating polymer coated paperboard panel with a film lip 17, having a perforated line along the folding line, with the film element outer lips nonpeelable side permanently heat sealed to the polymer coated paperboard panel.

According to FIG. 6, illustrating polymer coated paperboard panel permanently heat sealed to a film lip with polymer coated paperboard panel including the film lip, delaminating from the film in area 18 with the film lip being ripped off alone perforation line 19.

According to FIG. 7, illustrating the vertical 20 & diagonal 21 oriented knurled ultrasonic sonotrodes heat sealing pattern protruding from sonotrode base 22.

According to FIG. 8, illustrating polymer coated paperboard tabs 25 & 26, connected by perforation lines at the edge of polymer coated paperboard panel 23. Polymer coated paperboard tabs 25 & 26, furthermore heat sealed to polymer coated paperboard panel 23. Tab 26 with combine perforation line length generally>half the total length across the tab with the first perforation cut starting at the paperboard edge, the entire tab 25 will be ripped off when lifted up by the not sealed paperboard panel 23, and tab 26 with combined perforation line length generally<half the total length across, the tab with the first perforation cut not starting at the paperboard edge, delaminating with one paperboard tab 26 layer remain connected to polymer coated paperboard panel 23 and with the other paperboard tab 25 layer remain connected to polymer coated paperboard panel 24 along the perforation line, in which panel 26 can be ripped off, providing touchless opening of the closure.

According to FIG. 9, illustrating four hollow alloy pins 28, preventing heat transfer from heated (200° C.) mandrel top plate 27 into mandrel base 29. When the mandrel top plate 29 temperature decreases to a predetermined level, an wireless infrared sensor sends a signal to a temperature controller which activate an induction coil and as the mandrels top plate 27 passes under the induction coil, the ferromagnetic material in mandrel top plate 27 is heated activated, keeping the mandrel top plate 27 at a temp. ±10 200° C. at all times. Alternatively, a hot air blower or an infrared heating element, switched on & off, directed at the mandrel top plate 27. A 100-150 watt heat element integrated in the mandrel top plate 27 is a third alternative, controlled by an infrared wireless sensor with an image recognition camera reading each mandrels individual image, recognizing respective mandrels top plate temperature and sending signals to the mandrel's top plate temperature controller. Each four lanes have four rotating mandrels connected to an indexing shaft. Eighteen power supply wires connected to the sixteen heat elements in the mandrel top plates 27 and connected through; hollow pins 28, mandrel base 29 and the shaft center with a nine channels slip ring coupling on each end of the indexing mandrel shaft.

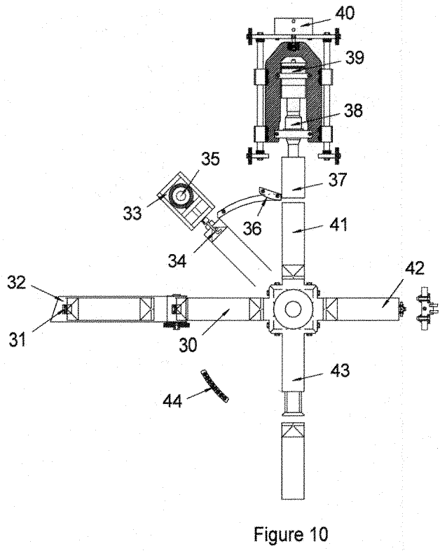

According to FIG. 10, illustrating a side view of the four mandrels indexing rotor first mandrel 30 with a rectangular container sleeve pushed onto the mandrel by an indexing stainless steel front enforced polymer paddle 31 welded onto an endless steel reinforced polyurethane (PUR) timing belt 32. The closure is folded between first left oriented mandrel 30 and second above oriented mandrel 41 by a rotating bevel gear box 33, having two folding arms 34 with different length each side of the closure, swiveling in different directions and prefolding the closure as the gearbox tuning around a stationary center shaft 35 with two guides 36 having different profile levels, folding the closure plane before entering underneath the ultrasonic sonotrode 37. Top oriented mandrel station sealing the container closure by an ultrasonic stack comprising; sonotrode 37, booster 38 and converter 39, driven by a pneumatic actuator 40 oriented on center top of the ultrasonic stack. Right oriented third mandrel station 42 including an additional magnified compression die with a detailed view, compressing & heat sealing the presealed ultrasonic closures junction liquid proof, according to the present invention. In the fourth mandrel station 43 oriented below, vacuum cups pulling container's outside panels initially a very minor distance, releasing the inside container closure from the mandrels forehead with two arms furthermore pushing the rectangular carton structure with the folded closure out of the mandrel into a lower oriented pocket belt. Between lower fourth mandrel station 43 and first side left oriented mandrel station 30, an induction coil 44 embedded in a Teflon (PTFE) body is activated, keeping the mandrel top plate at a constant temperature.

The present invention should not be considered limited to the particular examples described above, but rather should be understood to cover all aspects equivalent methods and processes, as well as numerous materials and structures to which the present invention may be applicable, will be readily apparent to those of skilled in the art to which the present invention is directed upon review of the instant specifications.

1. A method of compressing & heat sealing an inside liquid container closure “junction” having a 180° folded polymer coated. paperboard panel edge between a polymer coated paperboard panel and a polymer coated film element edge area, wherein the 180° folded polymer coated paperboard panel edge and inside of the polymer coated paperboard panel, overlapping the polymer coated film element edge, characterized in that the folded, compressed, & pre-sealed container closure junction is compressed & heat sealed from the external container side by a punch having a hard ball formed forehead, said hard ball formed forehead is flexible and moving sideways after imprinting the containers said external polymer coated paperboard panel by hitting the 180° folded polymer coated paperboard edge during compression, heat sealing said 180° folded polymer coated paperboard edge between the containers outside said polymer coated paperboards inside panel and said polymer coated film element edge liquid proof without braking the polymer coating of the 180° folded paper board edge.

2. A method of compressing & heat sealing an inside section of a container closure for liquids according to claim 1, characterized in that a compression element having any forehead configuration, compressing a first panel against a 180° folded polymer coated paperboard edge between a second panel.

3. A method of compressing & heat sealing an inside section of a container closure for liquids according to claims 1 & 2, characterized in that a hard core compression & sealing punch forehead is sideways spring loaded or embedded in a flexible body, preferably Neoprene.

4. A method of compressing & heat sealing an inside section of a container closure junction for liquid according to claims 1 & 2, characterized in that a hard ball shaped forehead positioning a 180° folded polymer coated paperboard edge during compression.

5. A method of compressing & heat sealing an inside section of a container closure for liquids according to claims 1 & 2, characterized in that at least one compression & sealing punch is air or liquid cooled.

6. A method of compressing & heat sealing an inside section of a container closure for liquids according to claims 1 & 2, characterized in that the compressing & heat sealing punch forehead is vibrating.

7. A method of compressing & heat sealing an inside section of a container closure for liquids according to clams 1 & 2, characterized in that the compression & heat sealing punch ball shaped forehead is moving sideways, guided by the cartons 180° folded polymer coated paperboard panel edge during compression.

8. A method of compressing & heat sealing an inside section of a container closure for liquids according to claims 1 & 2, characterized in that the compression & heat sealing punch having a non-elastic forehead in punch-drive direction.

9. A method of compressing & heat sealing an inside section of a container closure for liquids according to claims 1 & 2, characterized in that the 180° polymer coated folded paperboard edge has at least one recessed section.

10. A method of compressing & heat sealing an inside section of a container closure for liquids according to claims 1 & 2, characterized in that the container panel wall or a film element consist of two or additional composite layers, combining any; paperboard, paper, aluminum foil, biopolymers, polyolefin polymers or polymer composites, non-peel able or peel able by a lacquer or a polymer.

11. A method of compressing & heat sealing an inside section of a container closure for liquid according to claims 1 & 2, characterized in that at least one compression & heat sealing punch is operating in at least one tool station.

12. A method of compressing & heat sealing an inside section of a container closure for liquid according to claims 1 & 2, characterized in that at least one compression & heat sealing punch having a flexible forehead embedded in an ultra-sonic heat sealing sonotrode, or in an induction, heat sealing tool.

13. A method of compressing & heat sealing an inside section of a container closure claims 1-12, characterized in that at least one compression & heat sealing punch comprising a stack independently movable elements integrated in a compression tool, said movable elements having generally straight panel sides, with any cross section profile, generally oriented & independently movable in operational direction, said elements having generally plane hard foreheads parallel oriented towards the mandrel surface with at least one said elements, spring loaded from the opposed side of said elements hard forehead.

14. A method of compressing & heat sealing an inside section of a container closure for liquid according to claims 1-13, characterized in that at least one compression & heat sealing punch is rotating, compressing & heat sealing a pre-folded flat container closures external panel against an inside the container rotating mandrel.

15. A method of compressing & heat sealing an inside section of a container closure for liquid according to claims 1-14, characterized in that a polymer coated paperboard tab is heat sealed to a polymer coated paperboard panel, said tab with combine perforation line length generally>half the total length across the entire said tab being ripped off when lifted up by the not sealed paperboard panel and said tab with combined perforation line length generally<half the total length across delaminating with one paperboard tab layer remain connected to polymer coated paperboard panel and with the other said paperboard tab layer remain connected to polymer coated paperboard panel along the perforation line, in which panel can be ripped off, providing touchless opening of the closure.
